(19) United States
(12) Patent Application Publication
(10) Pub. No.: US 2006/0292299 A1
(43) Pub. Date: Dec. 28, 2006

(54) Method for producing a continuous waterproofing flooring

(76) Inventor: Lionello Caregnato, Pieve di Soligo (IT)

Correspondence Address: Nord Resine, Via FornaceVecchia 79, Susegana, I-31058, IT

(21) Appl. No.: 10/540,214

(22) PCT Filed: Mar. 24, 2003
(86) PCT No.: PCT/IT03/00170

§ 371 Date: Jun. 20, 2005

(30) Foreign Application Priority Data
Dec. 20, 2002 (IT) TV02U000054

(51) Int. Cl. B05D 5/10

(52) U.S. Cl. 427/207.1

(57) ABSTRACT

The subject matter of the present invention is to provide a method for producing a continuous waterproofing flooring. This method consists in waterproofing a foundation (2) with the following coupled system: a) two component liquid applied waterproofing membrane (3) based on a hydraulic binders, with or without reinforcing fibrous base layer or mailing (4), that provides for water vapor permeability and watertightness; b) polymer-based coating (6), with or without aggregates, constituting the visible side of the walkable and vehicle-suitable flooring, characterized by high water vapor permeability. The flooring thus obtained is a continuous flooring with characteristics of high water vapor permeability and watertightness and characterized in that it's nonslip, self-cleaning, not subject to yellowing, wear and tear resistant.

Nowadays, in the building industry, the waterproofing of flat roofs, terraces, balconies and the like is performed by various methods, which can be distinguished according to the chemical nature of the covering. We'll now briefly analyse the performances of such covering in order to highlight those limitations which can be overcome by the present invention.

Bitumen-Based Waterproofing Sheets

Bitumen-based waterproofing sheets are usually fixed to the roof by means of flame heating or self-adhesive systems. During manufacturing they can be coated with protective elements, as foils or coloured marble chips. These elements improve the appearance, the weatherability, the wear resistance and the tear resistance of the sheet. Nevertheless this material can't be considered a pedestrian or vehicle-suitable floor coating because of thermoplastic behaviour of bitumen with increasing temperature; in the summer, indeed, bitumen-based sheets, even though protected, are damaged and deformed by pedestrian or vehicle traffic. This material, moreover, is not water vapor permeable, so that it's impossible also for very small amount of liquid water to evaporate from foundation.

Polyvinylchloride-Based and Olefinic Rubber-Based Waterproofing Sheets

This material is made of very wide prefabricated rolled up sheets and it's sufficient to lay them on the roof, without any adhesive system, and cover them with gravel or earth to prevent any movement. But if you want to make a concrete or tile flooring on this waterproofing material, you have not negligible additional cost due to the high cost of manual labour. Furthermore, neither of these sheets possess enough water vapor permeability to allow even the slightest percentage of water evaporation from foundation.

Resin-Based Waterproofing Materials (Two-Component Elastomeric Polyurethane, One-Component Urethane, Two-Component Epoxypolyurethane, Polyester, Two-Component Silicone Resins and Neoprene Resins)

These materials possess characteristics of application that get close to the subject matter of the present invention; however, they show the following disadvantages:
i) insufficient water vapor permeability to allow application on wet foundation (if applied at this condition, bubble forming and detachment of the resin coating from the lower layer will occur);
ii) high cost of raw materials;
iii) need of applying more than one coating of resin and aggregates, thus increasing manual labour cost;
   Flexible Two-Component Methacrylic Resin-Based Waterproofing Materials

These materials possess characteristics of application that get close to the subject matter of the present invention; however, they show the following disadvantages:
i) difficulties of application on very porous foundation (these materials are not fit to permeate and strengthen surfaces that will eventually have little cohesion);
ii) high cost of raw materials;
iii) high flammability of the components;
iv) high vapor pressure of the methacrylic monomer which implies a remarkable spreading of vapor and smell in the building site and the surroundings;
v) a marked tendency of the coating to yellowing.
   Latex-Based Waterproofing Membranes (Acrylic Esters, Styrene-Acrylate, and Acrylonitrile Latices)

These materials are a considerable part of the liquid applied waterproofing products in today's market. They show the following disadvantages:
i) insufficient permeability to water vapor to allow application on wet foundation (if applied on these conditions, bubble forming and detachment from foundation will occur);
ii) minimum film forming temperature higher than +7++8° C.;
   Liquid Applied Waterproofing Membranes Based on Cement-Latex Mix

These materials are constituted by a powder part containing a cement binder, and by a conveniently formulated liquid part containing polymeric latices. The waterproofing system thus obtained guarantees the permeability to water vapor and the impermeability to liquid water, but it cannot be considered flooring system since it does not possess enough aesthetic characteristics and tear resistance; therefore it is necessary to apply a protective finish (e.g. tile covering).

There are patents that deal with continuous waterproofing covering systems and refer to the use of materials and to the limitations above mentioned.

Accordingly, mention is made of U.S. Pat. No. 4,588,458, which discloses the use of a waterproofing membrane composed by a fibrous reinforcing base layer or matting impregnated with thermoplastic polymers-bitumen mix; GB 2193153, which discloses the use of a water vapor permeable felt constituted by non-woven fabric impregnated with bitumen on whose underside a film of perforated plastic material is applied, and then a thin metal layer; U.S. Pat. No. 4,897,313, which discloses the use of a waterproofing system composed by a first coating of butyl acrylate, styrene and acrylonitrile copolymer latex, and a prefabricated self-adhesive sheet of bitumen modified with elastic polymers; WO 01/72514, which discloses the use of covering panels composed by an upper coating of acrylonitrile, styrene and acrylic esters copolymers and of a lower coating of polyvinylchloride; U.S. Pat. No. 5,422,179, which discloses the use of waterproofing polymeric sheets obtained by copolymerization of ethylene, vinyl esters and acrylic esters; DE 3342560, which discloses the use of waterproofing sheets made of olefinic rubber strengthened with a fibreglass matting; U.S. Pat. No. 6,395,845, which discloses the use of epoxy resin-based waterproofing sheets; WO 94/04349, which discloses the use of flexible protective waterproofing sheets composed by a flexible polymeric foil impregnated with a cement binder-based material; EP 0794299, in which a reference is made about production method of flat covering can be obtained by applying two coatings of a cement binder-latex mix reinforced, in the middle, by a perforated polypropylene sheet.

A principal aim of the present invention is therefore to solve the described problems, eliminating the drawbacks of the mentioned prior art, by providing a method that allows the production of a continuous waterproofing flooring on flat roofs, terraces, balconies and other flat structures.

Within the scope of this aim, an important object of the present invention is to provide a continuous waterproofing flooring that can be applied on any surface, new or old, constituted by cement foundation, different kinds of tiles or natural and artificial stone coverings.

Another object of the present invention is to provide a continuous waterproofing flooring that can be applied even on wet foundation and with temperatures down to +0.5° C.

Another object of the present invention is to provide a continuous waterproofing flooring suitable for pedestrian and light vehicle use (with mass up to 3.5 tons), self-cleaning, nonslip, not subject to yellowing, wear and tear resistant.

Another object of the present invention is to provide a continuous waterproofing flooring that can be produced on site and in only two steps with a short interval of time between them.

This aim, these objects and others which will become apparent hereinafter are achieved by providing a method for producing a continuous waterproofing flooring, characterized in that it comprises the following steps:
a) a first step consisting in laying, on a previously prepared foundation, a layer of two-component liquid applied waterproofing membrane based on a hydraulic binder-latex mix, or laying a layer of two-component liquid applied waterproofing membrane based on hydraulic binder-latex mix followed by the laying and impregnation with the same liquid mix of a fibrous reinforcing base layer or matting;
b) a second step consisting in coating of the above described waterproofing membrane with a mix of polymers, additives, and eventually aggregates.

Further characteristics and advantages of the invention will become apparent evident from the following detailed description of a particular structure thereof, illustrated only by way of non-limitative example in the accompanying drawings, wherein:

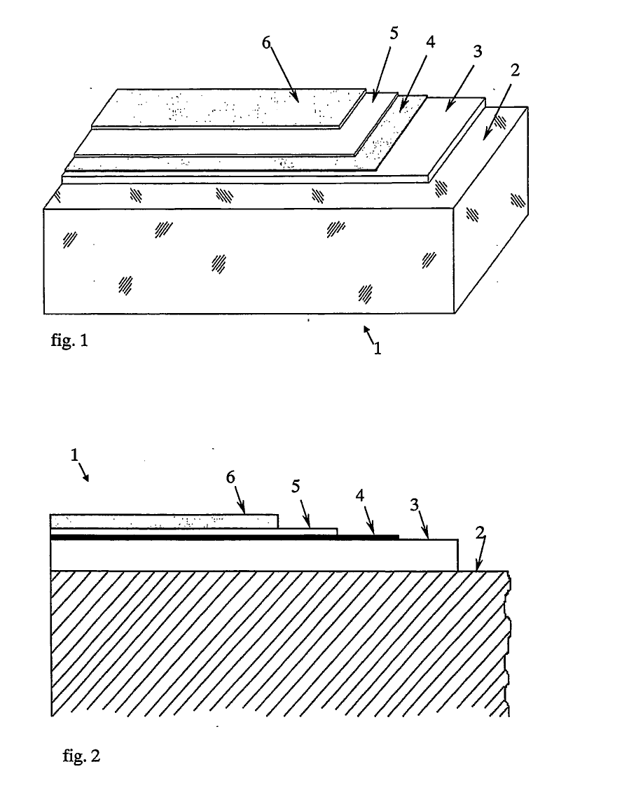

FIG. 1 is a perspective view of the flooring;

FIG. 2 is a sectional view of the flooring of FIG. 1.

With reference to the above figures, the reference numeral 1 designates a continuous waterproofing flooring for a previously prepared foundation 2 that is constituted by a base provided for example by means of a concrete casting.

The continuous waterproofing flooring is produced on site and entails the execution of both the above mentioned steps.

The first step consists in laying the layer 3 (two-component liquid applied waterproofing membrane based on a hydraulic binder-latex mix) on foundation 2. The two-component liquid applied waterproofing membrane based on a hydraulic binder-latex mix is composed of a mix of aggregates, additives, hydraulic binders, polymer latices and water obtained by mixing the dry and liquid components. Therefore the resulting material is composed of a mix of water, hydraulic binders and at least one polymer latex, for example styrene-acrylic esters latex. If necessary, just after the application of layer 3 is completed, you can proceed to lay a fibrous reinforcing base layer or matting 4 that can be constituited by non-woven fabric, felt, matting or any other structure that allows impregnation by and incorporation in layer 3; in this case it is advisable to lay on the fibrous reinforcing base layer or matting 4 a finishing layer 5 made of the same liquid mix. The interposition of the fibrous reinforcing base layer or matting 4 between the two layers of liquid mix allows to increase the tensile-strength characteristics of layer 3 and it should not alter the water vapor permeability of the system. Layers 3, 4 and 5 all together are waterproofing and water vapor permeable, so as to allow the laying of the system even on wet foundation. These characteristics are provided only by layer 3 when the liquid mix is applied without the fibrous reinforcing base layer or matting 4.

The second step consists in laying, on layer 5 (or 3, if the fibrous reinforcing base layer or matting 4 is not present), a pigmented or transparent mix of polymers and additives characterized by high water vapor permeability; this mix could eventually contain natural or artificial, coloured or not, aggregates.

The system obtained by laying the different components as described in the first and the second step, is the continuous waterproofing flooring, that is the object of the present invention.

The dimensions constituting the individual components of the product obtained with the present method can of course be the most appropriate according to the specific requirements.

Obviously, the method provided by the present invention is susceptible of changes, all of them being within the same inventive concept.

1. A method for producing a continuous waterproofing flooring characterized in that it's obtainable exclusively by coupling two distinct layers in according to the laying steps hereafter specified:
1.a) the first layer consisting in laying, on a previously prepared foundation, a composite system formed by a prefabricated fibrous reinforcing base layer or matting impregnated by a two-component liquid applied mix based on polymer latices and hydraulic binders;
1.b) the second layer consisting in the coating of the above described first layer with a mix of polymers and additives, with or without any kind of aggregates, so as to create the visible side of the walkable and vehicle-suitable flooring.

2. (canceled)

3. A method according to claim 1, characterized in that said impregnating two-component liquid applied mix of the composite system is composed by at least one polymer latex and one hydraulic binder.

4. A method according to claim 1, characterized in that the first layer has the ability to bridge the cracks in the foundation without losing its waterproofing ability.

5. A method according to claim 1, characterized in that said impregnating two-component liquid applied mix of the composite system acts as a waterproofing agent for the foundation.

6. A method according to claim 1, characterized in that said impregnating two-component liquid applied mix of the composite system makes the prefabricated fibrous reinforcing base layer or matting adhere to the foundation.

7. (canceled)

8. A method according to claim 1, characterized in that said prefabricated fibrous reinforcing base layer or matting can be made of woven-non-woven materials obtained from staple or continuous fibre, chopped strand matting, fibreglass net or net made of any kind of synthetic fibre, felt, mono-directional or multi-directional band made of carbon fibre, fibreglass or aromatic polyamides fibre, or any other material fit for the purpose.

9. A method according to claim 1, characterized in that at least one component of the coating, constituting the visible side of the walkable and vehicle-suitable flooring, is an acrylic polymer.

10. A method according to claim 1, characterized in that at least one component of the coating, constituting the visible side of the walkable and vehicle-suitable flooring, is a styrene-acrylic ester copolymer.

11. A method according to claim 1, characterized in that at least one component of the coating, constituting the visible side of the walkable and vehicle-suitable flooring, is an epoxy polymer.

12. A method according to claim 1, characterized in that at least one component of the coating, constituting the visible side of the walkable and vehicle-suitable flooring, is a methacrylic polymer.

13. A method according to claim 1, characterized in that at least one component of the coating, constituting the visible side of the walkable and vehicle-suitable flooring, is an unsaturated polyester resin.

14. A method according to claim 1, characterized in that at least one component of the coating, constituting the visible side of a walkable and vehicle-suitable flooring, is a polyurethane resin.

15. A method according to claim 1, characterized in that the polymer resins in the coating, constituting the visible side of the walkable and vehicle-suitable flooring, can be transparent, coloured or pigmented.

16. (canceled)
